(19) United States
(12) Patent Application Publication
(10) Pub. No.: US 2023/0206522 A1
(43) Pub. Date: Jun. 29, 2023

(54) TRAINING METHOD FOR HANDWRITTEN TEXT IMAGE GENERATION MODE, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Licheng TANG, Beijing (CN); Jiaming LIU, Beijing (CN); Taizhang SHANG, Beijing (CN)

(21) Appl. No.: 18/111,958

(22) Filed: Feb. 21, 2023

(30) Foreign Application Priority Data
Jun. 17, 2022 (CN) 2022106888162

(51) Int. Cl. G06T 11/20; G06V 30/19; G06V 30/22

(52) U.S. Cl. CPC G06T 11/203; G06V 30/19147; G06V 30/19127; G06V 30/22

(57) ABSTRACT

A training method for a handwritten text image generation model includes: obtaining training data including a sample content image, a first sample handwritten text image and a second sample handwritten text image, constructing an initial training model; obtaining a first predicted handwritten text image by inputting the sample content image and the second sample handwritten text image into an initial handwritten text image generation model of the initial training model; obtaining a second predicted handwritten text image by inputting the sample content image and the first sample handwritten text image into an initial handwritten text image reconstruction model of the initial training model; training the initial training model according to the first and second predicted handwritten text images and the first sample handwritten text image; and determining a handwritten text image generation model of the training model after training as a target handwritten text image generation model.

### CROSS-REFERENCE TO RELATED APPLICATION

This application claims priority to and benefits of Chinese Patent Application No. 202210688816.2, filed Jun. 17, 2022, the entire content of which is incorporated herein by reference.

### FIELD

The present disclosure relates to a computer technical field, more particularly to an artificial intelligence technical field, more particularly to technical fields of computer vision, image processing, and deep learning, and specifically to a training method for a handwritten text image generation model, a method for generating a handwritten text image, an electronic device and a storage medium.

### BACKGROUND

With the development of an image generation technology, the generation of handwritten text images has attracted more and more attention.

In the related art, it is important to develop a handwritten text image generation model for generating handwritten images conveniently.

### SUMMARY

The present disclosure provides a training method for a handwritten text image generation model, a method for generating a handwritten text image, an electronic device and a storage medium.

According to a first aspect of the present disclosure, a training method for a handwritten text image generation model is provided. The method includes: obtaining training data including a sample content image, a first sample handwritten text image and a second sample handwritten text image, in which the first sample handwritten text image has a same writing style as the second sample handwritten text image and has a same text content as the sample content image, and the second sample handwritten text image has a different text content from the sample content image; constructing an initial training model including an initial handwritten text image generation model and an initial handwritten text image reconstruction model; obtaining a first predicted handwritten text image by inputting the sample content image and the second sample handwritten text image into the initial handwritten text image generation model; obtaining a second predicted handwritten text image by inputting the sample content image and the first sample handwritten text image into the initial handwritten text image reconstruction model; training the initial training model according to the first predicted handwritten text image, the second predicted handwritten text image and the first sample handwritten text image; and determining a handwritten text image generation model of the training model after training as a target handwritten text image generation model.

According to a second aspect of the present disclosure, a method for generating a handwritten text image is provided. The method includes: obtaining a handwritten text; and obtaining the handwritten text image by inputting the handwritten text into the handwritten text image generation model obtained by the method according to the second aspect of the present disclosure.

According to a third aspect of the present disclosure, an electronic device is provided. The electronic device includes at least one processor; and a memory communicatively connected to the at least one processor and having stored therein instructions executable by the at least one processor. The at least one processor is configured to execute the instructions to perform the training method for the handwritten text image generation model in the present disclosure.

According to a fourth aspect of the present disclosure, a non-transitory computer-readable storage medium is provided. The storage medium has stored therein computer instructions that, when executed by a computer, cause the computer to perform the training method for the handwritten text image generation model in the present disclosure.

It should be understood that the content described in this part is neither intended to identify key or significant features of embodiments of the present disclosure, nor intended to limit the scope of the present disclosure. Other features of the present disclosure will be easier to understand through the following description.

### BRIEF DESCRIPTION OF THE DRAWINGS

The accompanying drawings are intended to provide a better understanding of the present disclosure and do not constitute a limitation on the present disclosure, in which:

FIG. 1 is a schematic flowchart showing a training method for a handwritten text image generation model according to some embodiments of the present disclosure;

FIG. 2 is a schematic flowchart showing a training method for a handwritten text image generation model according to some embodiments of the present disclosure;

FIG. 3 is a schematic flowchart showing a training method for a handwritten text image generation model according to some embodiments of the present disclosure;

FIG. 4 is a schematic diagram showing acquisition of an attention result according to some embodiments of the present disclosure;

FIG. 5 is a schematic flowchart showing a training method for a handwritten text image generation model according to some embodiments of the present disclosure;

FIG. 6 is a schematic flowchart showing a training method for a handwritten text image generation model according to some embodiments of the present disclosure;

FIG. 7 is a schematic flowchart showing a training method for a handwritten text image generation model according to some embodiments of the present disclosure;

FIG. 8 is a schematic flowchart showing a training method for a handwritten text image generation model according to some embodiments of the present disclosure;

FIG. 9 is a schematic diagram showing a structure of an initial training model and the determination of a total loss value of the initial training model according to some embodiments of the present disclosure;

FIG. 10 is a schematic block diagram showing a training apparatus for a handwritten text image generation model according to some embodiments of the present disclosure;

FIG. 11 is a schematic block diagram showing a training apparatus for a handwritten text image generation model according to some embodiments of the present disclosure; and

FIG. 12 is a block diagram of an electronic device configured to perform a training method for a handwritten text image generation model in embodiments of the present disclosure.

### DETAILED DESCRIPTION

Embodiments of the present disclosure are illustrated below with reference to the accompanying drawings, which include various details to facilitate understanding and should be considered only as explanatory and illustrative. Therefore, those skilled in the art should be aware that various changes and modifications can be made to embodiments described herein without departing from the scope and spirit of the present disclosure. Similarly, for clarity and simplicity, descriptions of well-known functions and structures are omitted in the following description.

During training a handwritten text image generation model, since it takes a long time and a high cost to collect sample content images and corresponding handwritten text images, in the related art, the handwritten text image generation model is generally trained by using sample content images that have different text contents and sample handwritten text images. However, the handwritten text image generation model trained by this training method has a poor model convergence.

For this, according to the present disclosure, a sample content image and a second sample handwritten text image in training data are input into an initial handwritten text image generation model of a training model to obtain a first predicted handwritten text image, the sample content image and a first sample handwritten text image in the training data are input into an initial handwritten text image reconstruction model of the training model to obtain a second predicted handwritten text image, the training model is trained according to the first predicted handwritten text image, the second predicted handwritten text image and the first sample handwritten text image, and a handwritten text image generation model of the training model after training is determined as a target handwritten text image generation model. In this way, in the model training process, the training model is trained according to the second predicted handwritten text image output from the initial handwritten text image reconstruction model, the first predicted handwritten text image output from the initial handwritten text image generation model and the sample handwritten text image, which may improve a convergence speed of the training model, thereby speeding up the convergence of the handwritten text image generation model of the training model and improving a training efficiency of the handwritten text image generation model.

A training method and apparatus for a handwritten text image generation model, and a storage medium in embodiments of the present disclosure are described below with reference to the accompanying drawings.

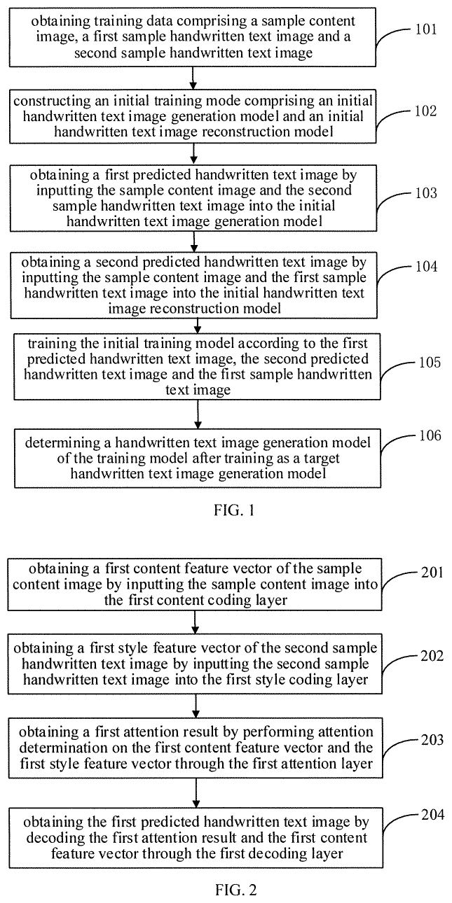

FIG. 1 is a schematic flowchart showing a training method for a handwritten text image generation model according to some embodiments of the present disclosure. In this embodiment, a training method for a handwritten text image generation model is provided.

As shown in FIG. 1, the training method for the handwritten text image generation model includes the following steps 101 to 106.

In step 101, training data is obtained. The training data includes a sample content image, a first sample handwritten text image and a second sample handwritten text image.

It should be noted that an executing subject of the training method for the handwritten text image generation model is a training apparatus for a handwritten text image generation model. The training apparatus for the handwritten text image generation model may be implemented by a software and/or a hardware. The training apparatus for the handwritten text image generation model may be an electronic device, or be configured in an electronic device.

The electronic device may include, but is not limited to, a terminal device, a server and so on, which is not limited in the present disclosure.

The sample content image may be an image containing a text in a standard font, such as Song typeface font, regular script font and so on.

The text in the standard font may be a single character or a text line containing multiple characters, such as words or sentences. In some embodiments, the text in the standard font being the single character is taken as an example for illustrative description.

Both the first sample handwritten text image and the second sample handwritten text image are images containing a handwritten text. It should be noted that, the first sample handwritten text image has a same writing style as the second sample handwritten text image, but the first sample handwritten text image has a different handwritten text from the second sample handwritten text image. That is to say, the first sample handwritten text image has a different text content from the second sample handwritten text image.

The first sample handwritten text image has a same text content as the sample content image.

The second sample handwritten text image has a different text content from the sample content image.

For example, the text content in the sample content image may be a character “ [symbol] ” in a regular script font. The text content in the first sample handwritten text image may be a character “ [symbol] ” handwritten by a user. The text content in the second sample handwritten text image may be a character handwritten by a user, such as “ [symbol] ” and the like. It should be noted that even through the text content in the first sample handwritten text image is different from the text content in the second sample handwritten text image, the writing style of the text content in the first sample handwritten text image is the same as the writing style of the text content in the second sample handwritten text image. In some embodiments, the text content in the first sample handwritten text image and the text content in the second sample handwritten text image may be handwritten by the same user, or may be handwritten by different users in the same writing style, which is not limited herein.

In step 102, an initial training model is constructed. The initial training model includes an initial handwritten text image generation model and an initial handwritten text image reconstruction model.

A model structure of the initial handwritten text image generation model may be the same as or different from a model structure of the initial handwritten text image reconstruction model, which is not limited in embodiments of the present disclosure.

In step 103, the sample content image and the second sample handwritten text image are input into the initial handwritten text image generation model to obtain a first predicted handwritten text image.

In step 104, the sample content image and the first sample handwritten text image are input into the initial handwritten text image reconstruction model to obtain a second predicted handwritten text image.

In step 105, the initial training model is trained according to the first predicted handwritten text image, the second predicted handwritten text image and the first sample handwritten text image.

In step 106, a handwritten text image generation model of the training model after training is determined as a target handwritten text image generation model.

It should be noted that the above-mentioned target handwritten text image generation model is configured to generate a handwritten text image. For example, the handwritten text image is generated based on the target handwritten text image generation model by the following steps. A content image and a reference handwritten text image are obtained, and the content image and the reference handwritten text image are input into the target handwritten text image generation model. The target handwritten text image generation model performs style migration on the content image according to a writing style contained in the reference handwritten text image to obtain a target handwritten text image. The target handwritten text image has the same text content as the content image and has the same writing style as the reference handwritten text image.

The writing style contained in the reference handwritten text image is a writing style corresponding to a handwritten text in the reference handwritten text image.

According to the training method for the handwritten text image generation model in the present disclosure, the sample content image and the second sample handwritten text image in the training data are input into the initial handwritten text image generation model to obtain the first predicted handwritten text image. The sample content image and the first sample handwritten text image in the training data are input into the initial handwritten text image reconstruction model to obtain the second predicted handwritten text image. The initial training model is trained according to the first predicted handwritten text image, the second predicted handwritten text image and the first sample handwritten text image. The handwritten text image generation model of the training model after training is determined as the target handwritten text image generation model. In this way, in the model training process, the training model is trained according to the second predicted handwritten text image output from the initial handwritten text image reconstruction model, the first predicted handwritten text image output from the initial handwritten text image generation model and the first sample handwritten text image, which may improve a convergence speed of the training model, thereby speeding up the convergence of the handwritten text image generation model of the training model and improving a training efficiency of the handwritten text image generation model.

In some embodiments, in order to further make the writing style of a written text image generated by the handwritten text image generation model more natural, an attention layer may be added into the model structure of the initial handwritten text image generation model to improve attention to the writing style. In some embodiments, the initial handwritten text image generation model includes a first coding layer, a first attention layer and a first decoding layer that are connected in sequence. The first coding layer includes a first content coding layer and a first style coding layer. In some embodiments, obtaining the first predicted handwritten text image by inputting the sample content image and the second sample handwritten text image into the initial handwritten text image generation model in the above-mentioned step 103 may include the following steps 201 to 204, as shown in FIG. 2.

In step 201, the sample content image is input into the first content coding layer to obtain a first content feature vector of the sample content image.

The first content coding layer is configured to perform content coding on the sample content image to obtain the corresponding first content feature vector.

In step 202, the second sample handwritten text image is input into the first style coding layer to obtain a first style feature vector of the second sample handwritten text image.

The first style coding layer is configured to code the handwriting style in the second sample handwritten text image to obtain the corresponding first style feature vector.

In step 203, attention determination is performed on the first content feature vector and the first style feature vector through the first attention layer to obtain a first attention result.

In step 204, the first attention result and the first content feature vector are decoded through the first decoding layer to obtain the first predicted handwritten text image.

In some embodiments, the first attention result and the first content feature vector may be input into the first decoding layer. Correspondingly, the first decoding layer decodes the first attention result and the first content feature vector to obtain the first predicted handwritten text image.

In some embodiments, obtaining the first predicted handwritten text image by decoding the first attention result and the first content feature vector through the first decoding layer may include: obtaining a migration feature by performing style migration on the first content feature vector according to the first attention result, and obtaining the first predicted handwritten text image by decoding the migration feature.

In some embodiments, by adding the attention layer into the model structure of the initial handwritten text image generation model, the target handwritten text image generation model obtained from the training model after training also has the attention layer, so that the target handwritten text image generation model may increase the attention to the writing style through the attention layer, which improves the accuracy of the writing style of the written text image generated by the target handwritten text image generation model, and improves the authenticity of the generated handwritten text image.

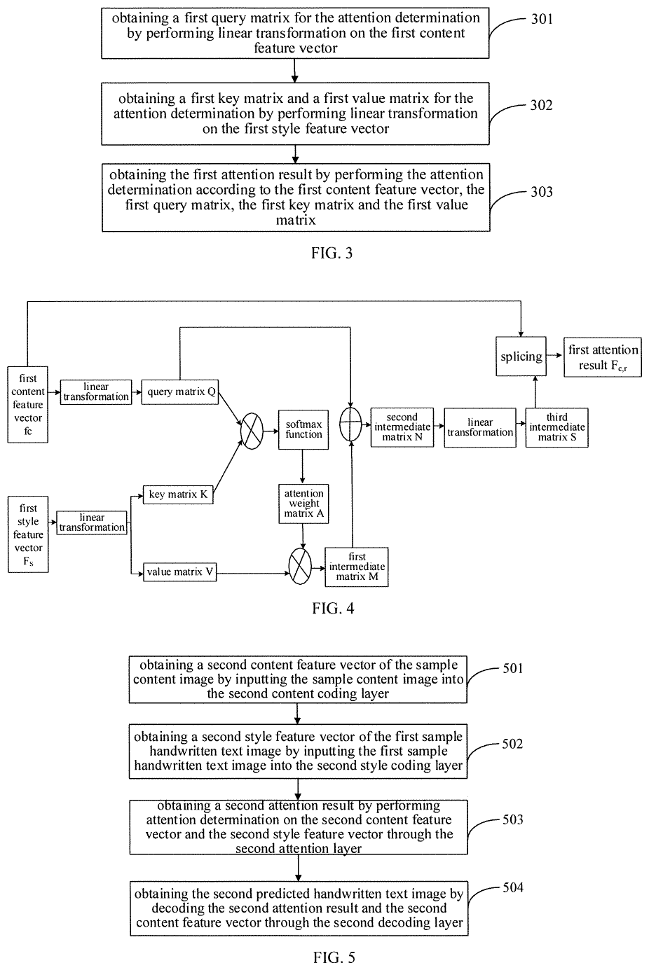

In some embodiments, in order to further improve the accuracy of the first attention result, obtaining the first attention result by performing attention determination on the first content feature vector and the first style feature vector through the first attention layer in the above-mentioned step 203 may include the following steps 301 to 303, as shown in FIG. 3.

In step 301, linear transformation is performed on the first content feature vector to obtain a first query matrix for the attention determination.

In step 302, linear transformation is performed on the first style feature vector to obtain a first key matrix and a first value matrix for the attention determination.

In step 303, the attention determination is performed according to the first content feature vector, the first query matrix, the first key matrix and the first value matrix to obtain the first attention result.

In some embodiments, in order to further improve the accuracy of the first attention result, obtaining the first attention result by performing the attention determination according to the first content feature vector, the first query matrix, the first key matrix and the first value matrix includes: obtaining a first attention weight matrix by performing matrix multiplication on the first query matrix and the first key matrix, obtaining a first intermediate matrix by performing matrix multiplication on the first attention weight matrix and the first value matrix, obtaining a second intermediate matrix by performing matrix addition on the first intermediate matrix and the first query matrix, obtaining a third intermediate matrix by performing linear transformation on the second intermediate matrix, and obtaining the first attention result by splicing the third intermediate matrix and the first content feature vector.

In order to clearly understand the present disclosure, the process of obtaining the first attention result through the first attention layer is described as follows with reference to FIG. 4.

After a first content feature vector fc and a first style feature vector F_{S} are obtained through a coding layer, the first content feature vector fc and the first style feature vector F_{S} are input into a first attention layer. The first attention layer performs the following processing: performing linear transformation on the first content feature vector fc to obtain a query matrix Q for the attention determination, performing linear transformation on the first style feature vector F_{S} to obtain a key matrix K and a value matrix V for the attention determination, performing matrix multiplication on the query matrix Q and the key matrix K to obtain a multiplication result, processing the obtained multiplication result through a normalized exponential function (for example, a softmax function) to obtain an attention weight matrix A, performing matrix multiplication on the attention weight matrix A and the value matrix V to obtain a first intermediate matrix M, performing matrix addition on the first intermediate matrix M and the query matrix Q to obtain a second intermediate matrix N, performing linear transformation on the second intermediate matrix N to obtain a third intermediate matrix S, and splicing the third intermediate matrix S and the first content feature vector fc to obtain a first attention result F_{c,r}.

It should be noted that the symbol “⊗” in FIG. 4 represents the matrix multiplication, and the symbol “⊗” in FIG. 4 represents the matrix addition.

In some embodiments, it should be noted that an attention mechanism of the attention layer may be a multi-head attention mechanism, which is not limited here.

In some embodiments, in order to make the writing style of the written text image reconstructed closer to a writing style of a real written text image, an attention layer may be added to the initial handwritten text image reconstruction model to increase the attention to the writing style. In some embodiments, the initial handwritten text image reconstruction model includes a second coding layer, a second attention layer and a second decoding layer that are connected in sequence. The second coding layer includes a second content coding layer and a second style coding layer. Obtaining the second predicted handwritten text image by inputting the sample content image and the first sample handwritten text image into the initial handwritten text image reconstruction model in the above-mentioned step 104 includes the following steps 501 to 504, as shown in FIG. 5.

In step 501, the sample content image is input into the second content coding layer to obtain a second content feature vector of the sample content image.

In some embodiments, the second content coding layer is configured to perform content coding on the sample content image to obtain the second content feature vector of the sample content image. Specifically, the second content coding layer performs content extraction on the sample content image, and codes the extracted content to obtain the second content feature vector.

In step 502, the first sample handwritten text image is input into the second style coding layer to obtain a second style feature vector of the first sample handwritten text image.

In some embodiments, the second style coding layer is configured to extract a writing style of the second sample handwritten text image, and code the extracted writing style to obtain the second style feature vector. The second style feature vector is configured to represent the writing style in the second sample handwritten text image.

In step 503, attention determination is performed on the second content feature vector and the second style feature vector through the second attention layer to obtain a second attention result.

In step 504, the second attention result and the second content feature vector are decoded through the second decoding layer to obtain the second predicted handwritten text image.

In some embodiments, in order to increase the attention to the writing style in the first sample handwritten text image during reconstructing the written text image through the initial handwritten text image reconstruction model, the attention layer may be added into the initial handwritten text image reconstruction model to increase the attention to the writing style, such that the writing style of the predicted handwritten text image output by the initial handwritten text image reconstruction model is more similar to the writing style of the first sample handwritten text image, which may further improve a convergence speed of the training model.

In some embodiments, in order to further improve the accuracy of the second attention result, as shown in FIG. 6, obtaining the second attention result by performing the attention determination on the second content feature vector and the second style feature vector through the second attention layer may include the following steps 601 to 603.

In step 601, linear transformation is performed on the second content feature vector to obtain a second query matrix for the attention determination.

In step 602, linear transformation is performed on the second style feature vector to obtain a second key matrix and a second value matrix for the attention determination.

In step 603, attention determination is performed according to the second content feature vector, the second query matrix, the second key matrix and the second value matrix to obtain the second attention result.

In some embodiments, in order to improve the accuracy of the second attention result, obtaining the second attention result by performing the attention determination according to the second content feature vector, the second query matrix, the second key matrix and the second value matrix includes: obtaining a second attention weight matrix by performing matrix multiplication on the second query matrix and the second key matrix; obtaining a fourth intermediate matrix by performing matrix multiplication on the second attention weight matrix and the second value matrix; obtaining a fifth intermediate matrix by performing matrix addition on the fourth intermediate matrix and the second query matrix; obtaining a sixth intermediate matrix by performing linear transformation on the fifth intermediate matrix; and obtaining the second attention result by splicing the sixth intermediate matrix and the second content feature vector.

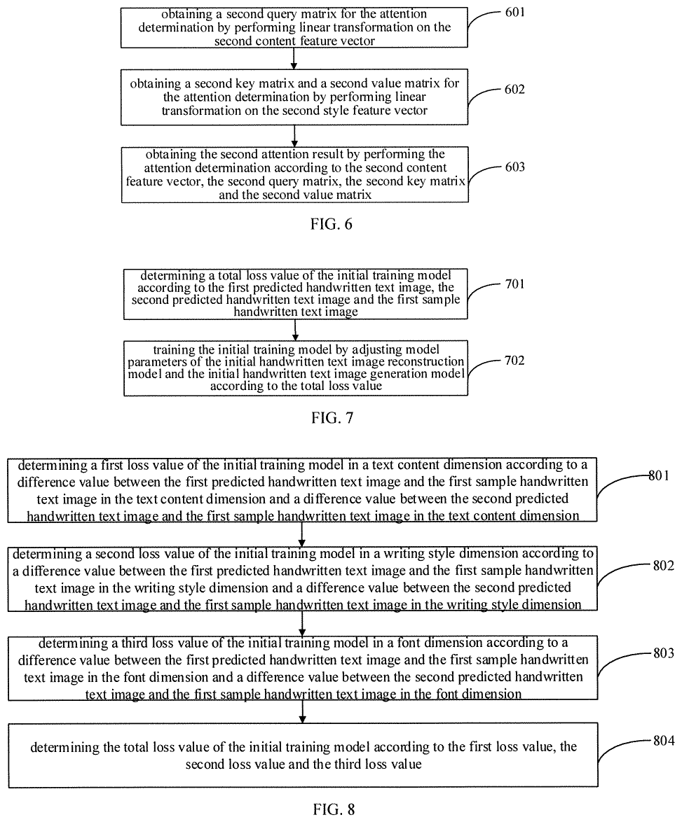

In some embodiments, based on any one of the above-mentioned embodiments, training the initial training model according to the first predicted handwritten text image, the second predicted handwritten text image and the first sample handwritten text image in the above-mentioned step 105 includes the following steps 701 to 702, as shown in FIG. 7.

In step 701, a total loss value of the initial training model is determined according to the first predicted handwritten text image, the second predicted handwritten text image and the first sample handwritten text image.

In step 702, the initial training model is trained by adjusting model parameters of the initial handwritten text image reconstruction model and the initial handwritten text image generation model according to the total loss value.

In some embodiments, the model parameters of the initial handwritten text image reconstruction model and the initial handwritten text image generation model in the training model may be adjusted according to the total loss value until the total loss value meets a preset condition to obtain the well-trained training model.

The preset condition is a condition for stopping the model training. The preset condition may be configured according to actual needs. For example, the preset condition may be that the total loss value is less than a preset value, or that a change trend of the total loss value tends to be stable, that is, a difference of total loss values that are obtained by two or more adjacent trainings is less than a preset value, that is, the total loss value basically does not change.

It could be understood that in the process of training the initial training model based on the training data, the model parameters of the initial training model are constantly adjusted according to the total loss value of each training. For example, the model parameters of the initial training model may be adjusted towards a trend where the total loss value decreases. When the total loss value meets the preset condition, the trained training model is obtained.

It could be understood that adjusting the model parameters of the initial training model includes adjusting the model parameters of the initial handwritten text image reconstruction model in the initial training model and the model parameters of the initial handwritten text image generation model in the initial training model.

In some embodiments, the total loss value of the initial training model is determined according to the first predicted handwritten text image, the second predicted handwritten text image and the first sample handwritten text image. Based on the total loss value, the model parameters of the initial handwritten text image reconstruction model and the initial handwritten text image generation model are adjusted to train the initial training model. In this way, the initial training model is trained by combining the second predicted handwritten text image reconstructed, which improves the model convergence speed of the training model.

In some embodiments, in order to further improve the accuracy of the target handwritten text image generation model obtained after training, during training the training model, the total loss value of the initial training model may be determined according to loss values of the initial training model in a plurality of dimensions that are determined according to the first predicted handwritten text image, the second predicted handwritten text image and the first sample handwritten text image. The plurality of dimensions corresponding to the initial training model may include a text content dimension, a writing style dimension and a font dimension. As shown in FIG. 8, determining the total loss value of the initial training model according to the first predicted handwritten text image, the second predicted handwritten text image and the first sample handwritten text image includes the following steps 801 to 804.

In step 801, a first loss value of the initial training model in a text content dimension is determined according to a difference value between the first predicted handwritten text image and the first sample handwritten text image in the text content dimension and a difference value between the second predicted handwritten text image and the first sample handwritten text image in the text content dimension.

In some embodiments, in order to make the text content of the first predicted handwritten text image consistent with the text content of the first sample handwritten text image, it may be determined whether the text content of the first predicted handwritten text image is correct according to the difference value between the first predicted handwritten text image and the first sample handwritten text image in the text content dimension. The smaller the difference value is, the higher the accuracy of the first predicted handwritten text image in the text content dimension is, otherwise, the larger the difference value is, the lower the accuracy of the first predicted handwritten text image in the text content dimension is. Through different iterative training, the text content of the first predicted handwritten text image is constrained to make it tend to be consistent with the text content of the sample content image.

In some embodiments, in order to make the text content of the second predicted handwritten text image be consistent with the text content of the first sample handwritten text image, it may be determined whether the text content on the second predicted handwritten text image is correct according to the difference value between the second predicted handwritten text image and the first sample handwritten text image in the text content dimension. The smaller the difference value is, the higher the accuracy of the second predicted handwritten text image in the text content dimension is, otherwise, the larger the difference value is, the lower the accuracy of the second predicted handwritten text image in the text content dimension is. Through different iterative training, the text content of the second predicted handwritten text image is constrained to make it tend to be consistent with the text content of the sample content image.

In step 802, a second loss value of the initial training model in a writing style dimension is determined according to a difference value between the first predicted handwritten text image and the first sample handwritten text image in the writing style dimension and a difference value between the second predicted handwritten text image and the first sample handwritten text image in the writing style dimension.

In some embodiments, in order to make the writing style of the first predicted handwritten text image consistent with a real writing style of the corresponding writer, a similarity between the writing style of the first predicted handwritten text image and the writing style of the first sample handwritten text image may be determined according to the difference value between the first predicted handwritten text image and the first sample handwritten text image in the writing style dimension. The smaller the difference value is, the higher the similarity between the first predicted handwritten text image and the first sample handwritten text image in the writing style dimension is, otherwise, the larger the difference value is, the lower the similarity between the first predicted handwritten text image and the first sample handwritten text image in the writing style dimension is. Through continuous iterative optimization, the first prediction handwritten text image is constrained to make it more and more similar to the first sample handwritten text image in the writing style dimension.

In some embodiments, in order to make the writing style of the second predicted handwritten text image consistent with the real writing style of the corresponding writer, a similarity between the writing style of the second predicted handwritten text image and the writing style of the first sample handwritten text image may be determined according to the difference value between the second predicted handwritten text image and the first sample handwritten text image in the writing style dimension. The smaller the difference value is, the higher the similarity between the second predicted handwritten text image and the first sample handwritten text image in the writing style dimension is, otherwise, the larger the difference value is, the lower the similarity between the second predicted handwritten text image and the first sample handwritten text image in the writing style dimension is. Through continuous iterative optimization, the second prediction handwritten text image is constrained to make it more and more similar to the first sample handwritten text image in the writing style dimension.

In step 803, a third loss value of the initial training model in a font dimension is determined according to a difference value between the first predicted handwritten text image and the first sample handwritten text image in the font dimension and a difference value between the second predicted handwritten text image and the first sample handwritten text image in the font dimension.

In some embodiments, in order to make the font of the first predicted handwritten text image consistent with the font of the first sample handwritten text image, it may be determined whether the font on the first predicted handwritten text image is correct according to the difference value between the first predicted handwritten text image and the first sample handwritten text image in the font dimension. The smaller the difference value is, the higher the accuracy of the first predicted handwritten text image in the font dimension is, otherwise, the larger the difference value is, the lower the accuracy of the first predicted handwritten text image in the font dimension is. Through different iterative training, the font of the first predicted handwritten text image is constrained to make it tend to be consistent with the font of the sample content image.

In some embodiments, in order to make the font of the second predicted handwritten text image consistent with the font of the first sample handwritten text image, it may be determined whether the font on the second predicted handwritten text image is correct according to the difference value between the second predicted handwritten text image and the first sample handwritten text image in the font dimension. The smaller the difference value is, the higher the accuracy of the second predicted handwritten text image in the font dimension is, otherwise, the larger the difference value is, the lower the accuracy of the second predicted handwritten text image in the font dimension is. Through different iterative training, the font of the second predicted handwritten text image is constrained to make it tend to be consistent with the font of the sample content image.

In some embodiments, in order to accurately determine the difference value between the first predicted handwritten text image and the first sample handwritten text image in the font dimension, determining the difference value between the first predicted handwritten text image and the first sample handwritten text image in the font dimension may include: determining a first pixel difference value between a pixel value of each pixel point in the first predicted handwritten text image and a pixel value of a pixel point at a corresponding position in the first sample handwritten text image; and obtaining the difference value between the first predicted handwritten text image and the first sample handwritten text image in the font dimension by averaging the first pixel difference values.

In some embodiments, in order to accurately determine the difference value between the second predicted handwritten text image and the first sample handwritten text image in the font dimension, determining the difference value between the second predicted handwritten text image and the first sample handwritten text image in the font dimension may include: determining a second pixel difference value between a pixel value of each pixel point in the second predicted handwritten text image and a pixel value of a pixel point at a corresponding position in the first sample handwritten text image; and obtaining the difference value between the second predicted handwritten text image and the first sample handwritten text image in the font dimension by averaging the second pixel difference values.

In step 804, the total loss value of the initial training model is determined according to the first loss value, the second loss value and the third loss value.

In some embodiments, the first loss value, the second loss value and the third loss value may be summed to obtain a sum value, and the obtained summing value may be determined as the total loss value of the initial training model.

In some embodiments, the first loss value, the second loss value and the third loss value may be subjected to weighted sum to obtain a weighted sum value, and the obtained weighted sum value may be determined as the total loss value of the initial training model.

In some embodiments, the total loss value of the initial training model may be determined according to the loss values of the initial training model in the plurality of dimensions that are determined according to the first predicted handwritten text image, the second predicted handwritten text image and the first sample handwritten text image, and the initial training model is trained according to the total loss value, which makes the output of the target handwritten text image generation model obtained from the training model more accurate and effective.

In some embodiments, in order to improve the effect of the handwritten text image output by the target handwritten text image generation model to avoid distortion, confrontation training may be performed on the training model with a discriminator model during training the training model.

In some embodiments, the discriminator model may be used to obtain a first determination result in the text content dimension according to the first predicted handwritten text image and the first sample handwritten text image, and to obtain a second determination result in the text content dimension according to the second predicted handwritten text image and the first sample handwritten text image. The discriminator model and training model are subjected to the confrontation training in the text content dimension according to the first determination result and the second determination result.

Furthermore, in addition to performing the confrontation training on the discriminator model and the training model in the text content dimension, it is also possible to perform the confrontation training on the discriminator model and the training model in the writing style dimension. Performing the confrontation training on the discriminator model and the training model in the writing style dimension may include: obtaining a first determination result in the writing style dimension through the discriminator mode according to the first predicted handwritten text image and the first sample handwritten text image; obtaining a second determination result in the writing style dimension through the discriminator model according to the second predicted handwritten text image and the first sample handwritten text image; and performing the confrontation training on the discriminator model and the training model in the writing style dimension according to the first determination result and the second determination result.

In some embodiments, the discriminator model and the training model may also be subjected to the confrontation training in the font dimension. Performing the confrontation training on the discriminator model and the training model in the font dimension may include: obtaining a first determination result in the font dimension through the discriminator model according to the first predicted handwritten text image and the first sample handwritten text image; obtaining a second determination result in the font dimension through the discriminator model according to the second predicted handwritten text image and the first sample handwritten text image; and performing the confrontation training on the discriminator model and the training model in the font dimension according to the first determination result and the second determination result.

In embodiments of the present disclosure, the confrontation training may improve the style migration ability of the target handwritten text image generation model with respect to the content image, which improves the accuracy of the writing style of the handwritten text image output by the target handwritten text image generation model, and improves the authenticity of the handwritten text image.

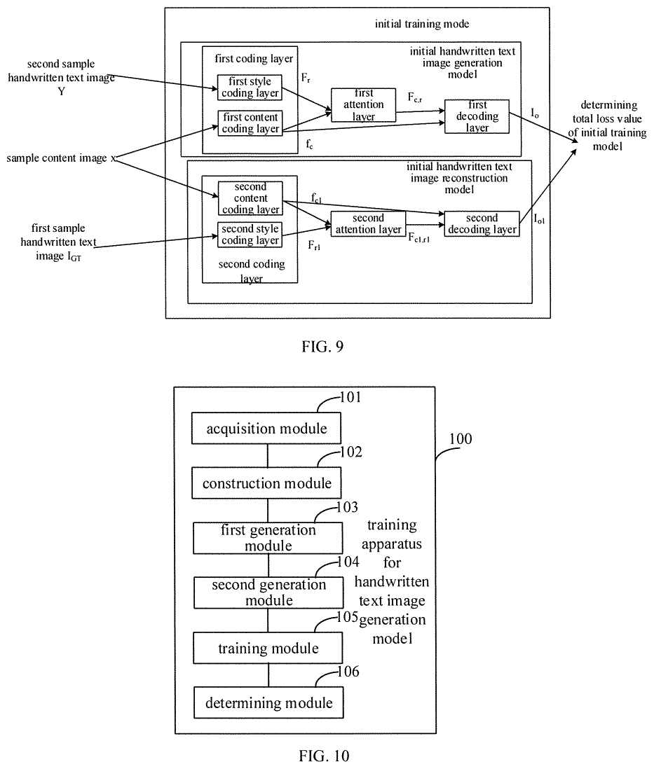

In order to clearly understand embodiments of the present disclosure, the training method according to embodiments of the present disclosure will be further described below with reference to FIG. 9. In some embodiments, the initial handwritten text image generation model in the initial training model has the same model structure and the same initial model parameters as the initial handwritten text image reconstruction model in the initial training model. As can be seen from FIG. 9, the initial handwritten text image generation model includes the first coding layer, the first attention layer and the first decoding layer that are connected in sequence, and the first coding layer includes the first content coding layer and the first style coding layer. Correspondingly, the initial handwritten text image reconstruction model includes the second coding layer, the second attention layer and the second decoding layer that are connected in sequence, and the second coding layer includes the second content coding layer and the second style coding layer.

Specifically, a sample content image x and a second sample handwritten text image Y are input into the initial handwritten text image generation model. The first content coding layer in the initial handwritten text image generation model performs content coding on the sample content image x to obtain a first content feature vector fc. Correspondingly, the first style coding layer in the initial handwritten text image generation model performs style coding on the second sample handwritten text image to obtain a first style feature vector Fr. The first attention layer performs attention determination on the first content feature vector fc and the first style feature vector Fr to obtain a first attention result F_{c,r}. The first decoding layer in the initial handwritten text image generation model decodes the first attention results F_{c,r} and the first content feature vector fc to obtain a first predicted handwritten text image Iₒ.

Correspondingly, the sample content image x and a first sample handwritten text image I_{GT} are input into the initial handwritten text image reconstruction model. The second content coding layer in the initial handwritten text image reconstruction model performs content coding on the sample content image x to obtain a second content feature vector f_{c1}. Correspondingly, the second style coding layer in the initial handwritten text image reconstruction model performs style coding on the first sample handwritten text image I_{GT} to obtain a second style feature vector Fᵣ₁. The second attention layer performs the attention calculation on the second content feature vector f_{c1} and the second style feature vector Fᵣ₁ to obtain a second attention results F_{c1,r1}. The second decoding layer in the initial handwritten text image reconstruction model decodes the second attention calculation results F_{c1,r1} and the second content feature vector f_{c1} to obtain a second predicted handwritten text image Iₒ₁.

The total loss value of the initial training model is determined according to the first predicted handwritten text image Iₒ, the second predicted handwritten text image Iₒ₁ and the first sample handwritten text image I_{GT}.

It should be noted that the specific process of determining the total loss value of the initial training model according to the first predicted handwritten text image Iₒ, the second predicted handwritten text image Iₒ₁ and the first sample handwritten text image I_{GT} may refer to the relevant descriptions in the above-mentioned embodiments, and will not be repeated here.

The initial training model is trained by adjusting the model parameters of the initial handwritten text image reconstruction model and the initial handwritten text image generation model according to the total loss value.

According to embodiments of the present disclosure, by providing the attention layer in each of the initial handwritten text image reconstruction model and the initial handwritten text image generation model, style modeling may be performed well through the attention layer. In addition, during the training process, the training is performed by combination of the initial handwritten text image reconstruction model with the initial handwritten text image generation model, such that the initial training model including the initial handwritten text image reconstruction model may be converged effectively and quickly, which improves the model training efficiency, and thus improves the efficiency of obtaining the trained target handwritten text image generation model.

Embodiments of the present disclosure further provide a method for generating a handwritten text image. The method includes: obtaining a handwritten text; and obtaining the handwritten text image by inputting the handwritten text into the handwritten text image generation model obtained by the training method as described in any of the above embodiments.

In order to realize the above-mentioned embodiments, the present disclosure further provides a training apparatus for a handwritten text image generation model.

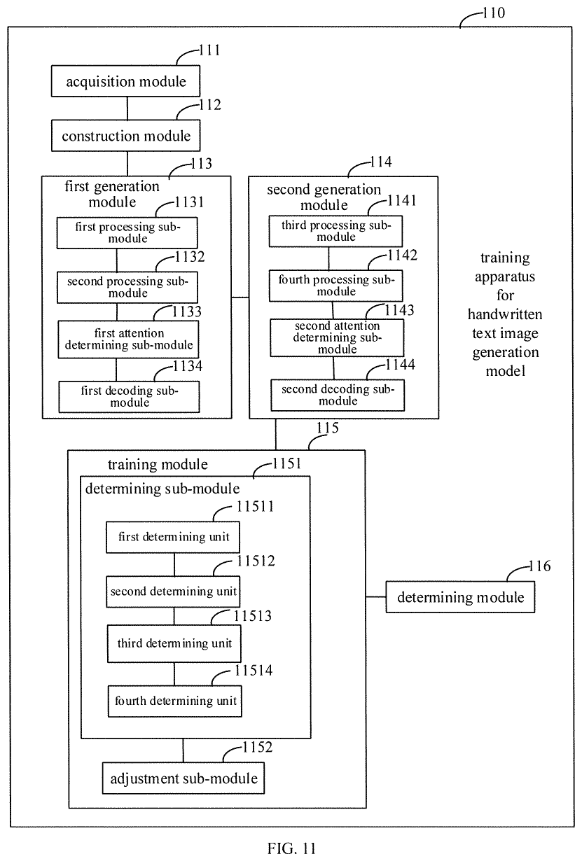

FIG. 10 is a schematic block diagram showing a training apparatus for a handwritten text image generation model according to some embodiments of the present disclosure. In these embodiments, a training apparatus for a handwritten text image generation model is provided.

As shown in FIG. 10, the training apparatus for the handwritten text image generation model may include an acquisition module 101, a construction module 102, a first generation module 103, a second generation module 104, a training module 105 and a determining module 106.

The acquisition module 101 is configured to obtain training data. The training data includes a sample content image, a first sample handwritten text image and a second sample handwritten text image. The first sample handwritten text image has a same writing style as the second sample handwritten text image and has a same text content as the sample content image, and the second sample handwritten text image has a different text content from the sample content image.

The construction module 102 is configured to construct an initial training model including an initial handwritten text image generation model and an initial handwritten text image reconstruction model.

The first generation module 103 is configured to obtain a first predicted handwritten text image by inputting the sample content image and the second sample handwritten text image into the initial handwritten text image generation model.

The second generation module 104 is configured to obtain a second predicted handwritten text image by inputting the sample content image and the first sample handwritten text image into the initial handwritten text image reconstruction model.

The training module 105 is configured to train the initial training model according to the first predicted handwritten text image, the second predicted handwritten text image and the first sample handwritten text image.

The determining module 106 is configured to determine a handwritten text image generation model of the training model after training as a target handwritten text image generation model.

In the training apparatus for the handwritten text image generation model according to embodiments of the present disclosure, the sample content image and the second sample handwritten text image in the training data are input into the initial handwritten text image generation model of the initial training model to obtain the first predicted handwritten text image. The sample content image and the first sample handwritten text image in the training data are input into the initial handwritten text image reconstruction model of the initial training model to obtain the second predicted handwritten text image. The initial training model is trained according to the first predicted handwritten text image, the second predicted handwritten text image and the first sample handwritten text image. The handwritten text image generation model of the training model after training is determined as the target handwritten text image generation model. In this way, in the model training process, the initial training model is trained according to the second predicted handwritten text image output from the initial handwritten text image reconstruction model, the first predicted handwritten text image output from the initial handwritten text image generation model and the first sample handwritten text image, which may improve a convergence speed of the training model, thereby speeding up the convergence of the handwritten text image generation model of the training model and improving the training efficiency of the handwritten text image generation model.

In some embodiments, as shown in FIG. 11, the training apparatus 110 for the handwritten text image generation model may include an acquisition module 111, a construction module 112, a first generation module 113, a second generation module 114, a training module 115 and a determining module 116. The first generation module 113 may include a first processing sub-module 1131, a second processing sub-module 1132, a first attention determining sub-module 1133 and a first decoding sub-module 1134. The second generation module 114 may include a third processing sub-module 1141, a fourth processing sub-module 1142, a second attention determining sub-module 1143 and a second decoding sub-module 1144. The training module 115 may include a determining sub-module 1151 and an adjustment sub-module 1152. The determining sub-module 1151 may include a first determining unit 11511, a second determining unit 11512, a third determining unit 11513 and a fourth determining unit 11514.

It should be noted that regarding the descriptions of the acquisition module 111, the construction module 112 and the determining module 116, reference may be made to the detailed descriptions of the acquisition module 101, the construction module 102 and the determining module 106 made above with reference to FIG. 10, which will not be repeated here.

In some embodiments, the initial handwritten text image generation model includes a first coding layer, a first attention layer and a first decoding layer that are connected in sequence. The first coding layer includes a first content coding layer and a first style coding layer.

The first generation module 113 includes the first processing sub-module 1131, the second processing sub-module 1132, the first attention determining sub-module 1133 and the first decoding sub-module 1134.

The first processing sub-module 1131 is configured to obtain a first content feature vector of the sample content image by inputting the sample content image into the first content coding layer.

The second processing sub-module 1132 is configured to obtain a first style feature vector of the second sample handwritten text image by inputting the second sample handwritten text image into the first style coding layer.

The first attention determining sub-module 1133 is configured to obtain a first attention result by performing attention determination on the first content feature vector and the first style feature vector through the first attention layer;

The first decoding sub-module 1134 is configured to obtain the first predicted handwritten text image by decoding the first attention result and the first content feature vector through the first decoding layer.

In some embodiments, the initial handwritten text image reconstruction model includes a second coding layer, a second attention layer and a second decoding layer that are connected in sequence. The second coding layer includes a second content coding layer and a second style coding layer.

The second generation module 114 includes the third processing sub-module 1141, the fourth processing sub-module 1142, the second attention determining sub-module 1143 and the second decoding sub-module 1144.

The third processing sub-module 1141 is configured to obtain a second content feature vector of the sample content image by inputting the sample content image into the second content coding layer.

The fourth processing sub-module 1142 is configured to obtain a second style feature vector of the first sample handwritten text image by inputting the first sample handwritten text image into the second style coding layer.

The second attention determining sub-module 1143 is configured to obtain a second attention result by performing attention determination on the second content feature vector and the second style feature vector through the second attention layer.

The second decoding sub-module 1144 is configured to obtain the second predicted handwritten text image by decoding the second attention result and the second content feature vector through the second decoding layer.

In some embodiments, the above-mentioned first attention determining sub-module 1133 is configured to: obtain a first query matrix for the attention determination by performing linear transformation on the first content feature vector; obtain a first key matrix and a first value matrix for the attention determination by performing linear transformation on the first style feature vector; and obtain the first attention result by performing the attention determination according to the first content feature vector, the first query matrix, the first key matrix and the first value matrix.

In some embodiments, the above-mentioned first attention determining sub-module 1133 is configured to: obtain a first attention weight matrix by performing matrix multiplication on the first query matrix and the first key matrix; obtain a first intermediate matrix by performing matrix multiplication on the first attention weight matrix and the first value matrix; obtain a second intermediate matrix by performing matrix addition on the first intermediate matrix and the first query matrix; obtain a third intermediate matrix by performing linear transformation on the second intermediate matrix; and obtain the first attention result by splicing the third intermediate matrix and the first content feature vector.

In some embodiments, the above-mentioned second attention determining sub-module 1143 is configured to: obtain a second query matrix for the attention determination by performing linear transformation on the second content feature vector; obtain a second key matrix and a second value matrix for the attention determination by performing linear transformation on the second style feature vector; and obtain the second attention result by performing the attention determination according to the second content feature vector, the second query matrix, the second key matrix and the second value matrix.

In some embodiments, the above-mentioned second attention determining sub-module 1143 is configured to: obtain a second attention weight matrix by performing matrix multiplication on the second query matrix and the second key matrix; obtain a fourth intermediate matrix by performing matrix multiplication on the second attention weight matrix and the second value matrix; obtain a fifth intermediate matrix by performing matrix addition on the fourth intermediate matrix and the second query matrix; obtain a sixth intermediate matrix by performing linear transformation on the fifth intermediate matrix; and obtain the second attention result by splicing the sixth intermediate matrix and the second content feature vector.

In some embodiments, the training module 115 includes the determining sub-module 1151 and the adjustment sub-module 1152.

The determining sub-module 1151 is configured to determine a total loss value of the initial training model according to the first predicted handwritten text image, the second predicted handwritten text image and the first sample handwritten text image.

The adjustment sub-module 1152 is configured to train the initial training model by adjusting model parameters of the initial handwritten text image reconstruction model and the initial handwritten text image generation model according to the total loss value.

In some embodiments, the determining sub-module 1151 includes the first determining unit 11511, the second determining unit 11512, the third determining unit 11513 and the fourth determining unit 11514.

The first determining unit 11511 is configured to determine a first loss value of the initial training model in a text content dimension according to a difference value between the first predicted handwritten text image and the first sample handwritten text image in the text content dimension and a difference value between the second predicted handwritten text image and the first sample handwritten text image in the text content dimension.

The second determining unit 11512 is configured to determine a second loss value of the initial training model in a writing style dimension according to a difference value between the first predicted handwritten text image and the first sample handwritten text image in the writing style dimension and a difference value between the second predicted handwritten text image and the first sample handwritten text image in the writing style dimension.

The third determining unit 11513 is configured to determine a third loss value of the initial training model in a font dimension according to a difference value between the first predicted handwritten text image and the first sample handwritten text image in the font dimension and a difference value between the second predicted handwritten text image and the first sample handwritten text image in the font dimension.

The fourth determining unit 11514 is configured to determine the total loss value of the initial training model according to the first loss value, the second loss value and the third loss value.

In some embodiments, the third determining unit 11513 is further configured to: determine a first pixel difference value between a pixel value of each pixel point in the first predicted handwritten text image and a pixel value of a pixel point at a corresponding position in the first sample handwritten text image; obtain the difference value between the first predicted handwritten text image and the first sample handwritten text image in the font dimension by averaging the first pixel difference values; determine a second pixel difference value between a pixel value of each pixel point in the second predicted handwritten text image and a pixel value of a pixel point at a corresponding position in the first sample handwritten text image; and obtain the difference value between the second predicted handwritten text image and the first sample handwritten text image in the font dimension by averaging the second pixel difference values.

It should be noted that the above-mentioned descriptions of the training method for the handwritten text image generation model are also applicable to the training apparatus for the handwritten text image generation model in embodiments of the present disclosure, which will not be repeated herein.

According to embodiments of the present disclosure, the present disclosure further provides an electronic device, a readable storage medium and a computer program product.

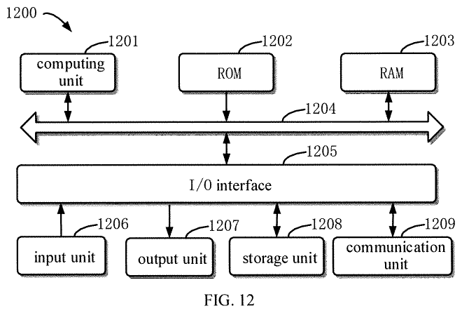

FIG. 12 is a block diagram of an electronic device 1200 configured to perform embodiments of the present disclosure. The electronic device is intended to represent various forms of digital computers, such as laptops, desktops, workbenches, personal digital assistants, servers, blade servers, mainframe computers and other suitable computing devices. The electronic device may further represent various forms of mobile devices, such as personal digital assistants, cellular phones, smart phones, wearable devices and other similar computing devices. The components, their connections and relationships, and their functions shown herein are examples only, and are not intended to limit the implementations of the present disclosure as described and/or claimed herein.

As shown in FIG. 12, the electronic device 1200 may include a computing unit 1201, which may perform various suitable actions and processing according to a computer program stored in a read-only memory (ROM) 1202 or a computer program loaded from a storage unit 1208 into a random access memory (RAM) 1203. The RAM 1203 may also store various programs and data required to operate the electronic device 1200. The computing unit 1201, the ROM 1202 and the RAM 1203 are connected to one another by a bus 1204. An input/output (I/O) interface 1205 is also connected to the bus 1204.

A plurality of components in the electronic device 1200 are connected to the I/O interface 1205, including an input unit 1206, such as a keyboard and a mouse; an output unit 1207, such as various displays and speakers; a storage unit 1208, such as disks and discs; and a communication unit 1209, such as a network card, a modem and a wireless communication transceiver. The communication unit 1209 allows the electronic device 1200 to exchange information/data with other devices over computer networks such as the Internet and/or various telecommunications networks.

The computing unit 1201 may be a variety of general-purpose and/or special-purpose processing components with processing and computing capabilities. Some examples of the computing unit 1201 include, but are not limited to, a central processing unit (CPU), a graphics processing unit (GPU), various artificial intelligence (AI) computing chips, various computing units that run machine learning model algorithms, a digital signal processor (DSP), and any appropriate processor, controller or microcontroller, etc. The computing unit 1201 performs the methods and processing described above, such as the training method for a handwritten text image generation model For example, in some embodiments, the training method for a handwritten text image generation model may be implemented as a computer software program that is tangibly embodied in a machine-readable medium, such as the storage unit 1208.

In some embodiments, part or all of a computer program may be loaded and/or installed on the electronic device 1200 via the ROM 1202 and/or the communication unit 1209. One or more steps of the training method for a handwritten text image generation model described above may be performed when the computer program is loaded into the RAM 1203 and executed by the computing unit 1201. Alternatively, in other embodiments, the computing unit 1201 may be configured to perform the training method for the handwritten text image generation model by any other appropriate means (for example, by means of firmware).

Various implementations of the systems and technologies disclosed herein can be realized in a digital electronic circuit system, an integrated circuit system, a field programmable gate array (FPGA), an application-specific integrated circuit (ASIC), an application-specific standard product (ASSP), a system on chip (SOC), a load programmable logic device (CPLD), computer hardware, firmware, software, and/or combinations thereof. Such implementations may include implementation in one or more computer programs that are executable and/or interpretable on a programmable system including at least one programmable processor, which can be special or general purpose, configured to receive data and instructions from a storage system, at least one input apparatus, and at least one output apparatus, and to transmit data and instructions to the storage system, the at least one input apparatus, and the at least one output apparatus.

Program codes configured to implement the methods in the present disclosure may be written in any combination of one or more programming languages. Such program codes may be supplied to a processor or controller of a general-purpose computer, a special-purpose computer, or another programmable data processing apparatus to enable the function/operation specified in the flowchart and/or block diagram to be implemented when the program codes are executed by the processor or controller. The program codes may be executed entirely on a machine, partially on a machine, partially on a machine and partially on a remote machine as a stand-alone package, or entirely on a remote machine or a server.

In the context of the present disclosure, machine-readable media may be tangible media which may include or store programs for use by or in conjunction with an instruction execution system, apparatus or device. The machine-readable media may be machine-readable signal media or machine-readable storage media. The machine-readable media may include, but are not limited to, electronic, magnetic, optical, electromagnetic, infrared, or semiconductor systems, apparatuses or devices, or any suitable combinations thereof. More specific examples of machine-readable storage media may include electrical connections based on one or more wires, a portable computer disk, a hard disk, a random access memory (RAM), a read-only memory (ROM), an erasable programmable read only memory (EPROM or flash memory), an optical fiber, a compact disk read only memory (CD-ROM), an optical storage device, a magnetic storage device, or any suitable combination thereof.

To provide interaction with a user, the systems and technologies described here can be implemented on a computer. The computer has: a display apparatus (e.g., a cathode-ray tube (CRT) or a liquid crystal display (LCD) monitor) for displaying information to the user; and a keyboard and a pointing apparatus (e.g., a mouse or trackball) through which the user may provide input for the computer. Other kinds of apparatuses may also be configured to provide interaction with the user. For example, a feedback provided for the user may be any form of sensory feedback (e.g., visual, auditory, or tactile feedback); and input from the user may be received in any form (including sound input, speech input, or tactile input).

The systems and technologies described herein can be implemented in a computing system including background components (e.g., as a data server), or a computing system including middleware components (e.g., an application server), or a computing system including front-end components (e.g., a user computer with a graphical user interface or web browser through which the user can interact with the implementation mode of the systems and technologies described here), or a computing system including any combination of such background components, middleware components or front-end components. The components of the system can be connected to each other through any form or medium of digital data communication (e.g., a communication network). Examples of the communication network include: a local area network (LAN), a wide area network (WAN), the Internet and a blockchain network.

The computer device may include a client and a server. The client and the server are generally far away from each other and generally interact via the communication network. A relationship between the client and the server is generated through computer programs that run on a corresponding computer and have a client-server relationship with each other. The server may be a cloud server, also known as a cloud computing server or cloud host, which is a host product in the cloud computing service system to solve the problems of difficult management and weak business scalability in the traditional physical host and a virtual private server (VPS). The server may also be a distributed system server, or a server combined with blockchain.

It should be noted that artificial intelligence (AI) is used for studying how to simulate some human thinking processes and intelligent behaviors (such as learning, reasoning, thinking, planning, etc.) through a computer, which includes both hardware and software technologies. AI hardware technologies generally include the technologies on such as sensors, special AI chips, cloud computing, distributed storage and big data processing, and AI software technologies generally include computer vision technology, speech recognition technology, natural language processing technology, machine learning/deep learning, big data processing technology, knowledge mapping technology and so on.

Embodiments of the present disclosure provide a computer program product. The computer program product includes a computer program that, when executed by a processor, causes the processor to perform the training method for the handwritten text image generation model in the present disclosure.

Embodiments of the present disclosure have the following advantages and beneficial effects.

The sample content image and the second sample handwritten text image in the training data are input into the initial handwritten text image generation model of the intimal training model to obtain the first predicted handwritten text image. The sample content image and the first sample handwritten text image in the training data are input into the initial handwritten text image reconstruction model of the intimal training model to obtain the second predicted handwritten text image. The initial training model is trained according to the first predicted handwritten text image, the second predicted handwritten text image and the first sample handwritten text image. The handwritten text image generation model of the training model after training is determined as the target handwritten text image generation model. In this way, in the model training process, the training model is trained according to the second predicted handwritten text image output from the initial handwritten text image reconstruction model, the first predicted handwritten text image output from the initial handwritten text image generation model and the first sample handwritten text image, which may improve a convergence speed of the training model, thereby speeding up the convergence of the handwritten text image generation model of the training model, and improving a training efficiency of the handwritten text image generation model.

It should be understood that the steps can be reordered, added, or deleted using the various forms of processes shown above. For example, the steps described in the present disclosure may be executed in parallel or sequentially or in different sequences, provided that desired results of the technical solutions disclosed in the present disclosure are achieved, which is not limited herein.

The above-mentioned embodiments do not limit the extent of protection of the present disclosure. Those skilled in the art should understand that various modifications, combinations, sub-combinations, and replacements can be made according to design requirements and other factors. Any modifications, equivalent substitutions and improvements made within the spirit and principle of the present disclosure all should be included in the extent of protection of the present disclosure.

What is claimed is:

1. A training method for a handwritten text image generation model, comprising:
obtaining training data comprising a sample content image, a first sample handwritten text image and a second sample handwritten text image, wherein the first sample handwritten text image has a same writing style as the second sample handwritten text image and has a same text content as the sample content image, and the second sample handwritten text image has a different text content from the sample content image;
constructing an initial training model comprising an initial handwritten text image generation model and an initial handwritten text image reconstruction model;
obtaining a first predicted handwritten text image by inputting the sample content image and the second sample handwritten text image into the initial handwritten text image generation model;
obtaining a second predicted handwritten text image by inputting the sample content image and the first sample handwritten text image into the initial handwritten text image reconstruction model;
training the initial training model according to the first predicted handwritten text image, the second predicted handwritten text image and the first sample handwritten text image; and
determining a handwritten text image generation model of the training model after training as a target handwritten text image generation model.

2. The method according to claim 1, wherein the initial handwritten text image generation model comprises a first coding layer, a first attention layer and a first decoding layer that are connected in sequence;
the first coding layer comprises a first content coding layer and a first style coding layer;
wherein obtaining the first predicted handwritten text image by inputting the sample content image and the second sample handwritten text image into the initial handwritten text image generation model comprises:
obtaining a first content feature vector of the sample content image by inputting the sample content image into the first content coding layer;
obtaining a first style feature vector of the second sample handwritten text image by inputting the second sample handwritten text image into the first style coding layer;
obtaining a first attention result by performing attention determination on the first content feature vector and the first style feature vector through the first attention layer; and
obtaining the first predicted handwritten text image by decoding the first attention result and the first content feature vector through the first decoding layer.

3. The method according to claim 1, wherein the initial handwritten text image reconstruction model comprises a second coding layer, a second attention layer and a second decoding layer that are connected in sequence;
the second coding layer comprises a second content coding layer and a second style coding layer;
wherein obtaining the second predicted handwritten text image by inputting the sample content image and the first sample handwritten text image into the initial handwritten text image reconstruction model comprises:
obtaining a second content feature vector of the sample content image by inputting the sample content image into the second content coding layer;
obtaining a second style feature vector of the first sample handwritten text image by inputting the first sample handwritten text image into the second style coding layer;
obtaining a second attention result by performing attention determination on the second content feature vector and the second style feature vector through the second attention layer; and
obtaining the second predicted handwritten text image by decoding the second attention result and the second content feature vector through the second decoding layer.

4. The method according to claim 2, wherein obtaining the first attention result by performing the attention determination on the first content feature vector and the first style feature vector through the first attention layer comprises:
obtaining a first query matrix for the attention determination by performing linear transformation on the first content feature vector;
obtaining a first key matrix and a first value matrix for the attention determination by performing linear transformation on the first style feature vector; and
obtaining the first attention result by performing the attention determination according to the first content feature vector, the first query matrix, the first key matrix and the first value matrix.

5. The method according to claim 4, wherein obtaining the first attention result by performing the attention determination according to the first content feature vector, the first query matrix, the first key matrix and the first value matrix comprises:
obtaining a first attention weight matrix by performing matrix multiplication on the first query matrix and the first key matrix;
obtaining a first intermediate matrix by performing matrix multiplication on the first attention weight matrix and the first value matrix;
obtaining a second intermediate matrix by performing matrix addition on the first intermediate matrix and the first query matrix;
obtaining a third intermediate matrix by performing linear transformation on the second intermediate matrix; and
obtaining the first attention result by splicing the third intermediate matrix and the first content feature vector.

6. The method according to claim 3, wherein obtaining the second attention result by performing the attention determination on the second content feature vector and the second style feature vector through the second attention layer comprises:
obtaining a second query matrix for the attention determination by performing linear transformation on the second content feature vector;
obtaining a second key matrix and a second value matrix for the attention determination by performing linear transformation on the second style feature vector; and
obtaining the second attention result by performing the attention determination according to the second content feature vector, the second query matrix, the second key matrix and the second value matrix.

7. The method according to claim 6, wherein obtaining the second attention result by performing the attention determination according to the second content feature vector, the second query matrix, the second key matrix and the second value matrix comprises:
obtaining a second attention weight matrix by performing matrix multiplication on the second query matrix and the second key matrix;
obtaining a fourth intermediate matrix by performing matrix multiplication on the second attention weight matrix and the second value matrix;
obtaining a fifth intermediate matrix by performing matrix addition on the fourth intermediate matrix and the second query matrix;
obtaining a sixth intermediate matrix by performing linear transformation on the fifth intermediate matrix; and
obtaining the second attention result by splicing the sixth intermediate matrix and the second content feature vector.

8. The method according to claim 1, wherein training the initial training model according to the first predicted handwritten text image, the second predicted handwritten text image and the first sample handwritten text image comprises:
determining a total loss value of the initial training model according to the first predicted handwritten text image, the second predicted handwritten text image and the first sample handwritten text image; and
training the initial training model by adjusting model parameters of the initial handwritten text image reconstruction model and the initial handwritten text image generation model according to the total loss value.

9. The method according to claim 8, wherein determining the total loss value of the initial training model according to the first predicted handwritten text image, the second predicted handwritten text image and the first sample handwritten text image comprises:
determining a first loss value of the initial training model in a text content dimension according to a difference value between the first predicted handwritten text image and the first sample handwritten text image in the text content dimension and a difference value between the second predicted handwritten text image and the first sample handwritten text image in the text content dimension;
determining a second loss value of the initial training model in a writing style dimension according to a difference value between the first predicted handwritten text image and the first sample handwritten text image in the writing style dimension and a difference value between the second predicted handwritten text image and the first sample handwritten text image in the writing style dimension;
determining a third loss value of the initial training model in a font dimension according to a difference value between the first predicted handwritten text image and the first sample handwritten text image in the font dimension and a difference value between the second predicted handwritten text image and the first sample handwritten text image in the font dimension; and
determining the total loss value of the initial training model according to the first loss value, the second loss value and the third loss value.

10. The method according to claim 9, further comprising:
determining a first pixel difference value between a pixel value of each pixel point in the first predicted handwritten text image and a pixel value of a pixel point at a corresponding position in the first sample handwritten text image;
obtaining the difference value between the first predicted handwritten text image and the first sample handwritten text image in the font dimension by averaging the first pixel difference values;
determining a second pixel difference value between a pixel value of each pixel point in the second predicted handwritten text image and a pixel value of a pixel point at a corresponding position in the first sample handwritten text image; and
obtaining the difference value between the second predicted handwritten text image and the first sample handwritten text image in the font dimension by averaging the second pixel difference values.

11. A method for generating a handwritten text image, comprising:
obtaining a handwritten text; and
obtaining the handwritten text image by inputting the handwritten text into the handwritten text image generation model obtained by the method of claim 1.

12. An electronic device, comprising:
at least one processor; and
a memory communicatively connected to the at least one processor and having stored therein instructions executable by the at least one processor;
wherein the at least one processor is configured to execute the instructions to:
obtain training data comprising a sample content image, a first sample handwritten text image and a second sample handwritten text image, wherein the first sample handwritten text image has a same writing style as the second sample handwritten text image and has a same text content as the sample content image, and the second sample handwritten text image has a different text content from the sample content image;
construct an initial training model comprising an initial handwritten text image generation model and an initial handwritten text image reconstruction model;
obtain a first predicted handwritten text image by inputting the sample content image and the second sample handwritten text image into the initial handwritten text image generation model;
obtaining a second predicted handwritten text image by inputting the sample content image and the first sample handwritten text image into the initial handwritten text image reconstruction model;
train the initial training model according to the first predicted handwritten text image, the second predicted handwritten text image and the first sample handwritten text image; and
determine a handwritten text image generation model of the training model after training as a target handwritten text image generation model.

13. The electronic device according to claim 12, wherein the initial handwritten text image generation model comprises a first coding layer, a first attention layer and a first decoding layer that are connected in sequence;
the first coding layer comprises a first content coding layer and a first style coding layer;
wherein the at least one processor is configured to execute the instructions to:
obtain a first content feature vector of the sample content image by inputting the sample content image into the first content coding layer;
obtain a first style feature vector of the second sample handwritten text image by inputting the second sample handwritten text image into the first style coding layer;
obtain a first attention result by performing attention determination on the first content feature vector and the first style feature vector through the first attention layer; and
obtain the first predicted handwritten text image by decoding the first attention result and the first content feature vector through the first decoding layer.

14. The electronic device according to claim 12, wherein the initial handwritten text image reconstruction model comprises a second coding layer, a second attention layer and a second decoding layer that are connected in sequence;
the second coding layer comprises a second content coding layer and a second style coding layer;
wherein the at least one processor is configured to execute the instructions to:
obtain a second content feature vector of the sample content image by inputting the sample content image into the second content coding layer;
obtain a second style feature vector of the first sample handwritten text image by inputting the first sample handwritten text image into the second style coding layer;
obtain a second attention result by performing attention determination on the second content feature vector and the second style feature vector through the second attention layer; and
obtain the second predicted handwritten text image by decoding the second attention result and the second content feature vector through the second decoding layer.

15. The electronic device according to claim 13, wherein the at least one processor is configured to execute the instructions to:
obtain a first query matrix for the attention determination by performing linear transformation on the first content feature vector;
obtain a first key matrix and a first value matrix for the attention determination by performing linear transformation on the first style feature vector; and
obtain the first attention result by performing the attention determination according to the first content feature vector, the first query matrix, the first key matrix and the first value matrix.

16. The electronic device according to claim 15, wherein the at least one processor is configured to execute the instructions to:
obtain a first attention weight matrix by performing matrix multiplication on the first query matrix and the first key matrix;
obtain a first intermediate matrix by performing matrix multiplication on the first attention weight matrix and the first value matrix;
obtain a second intermediate matrix by performing matrix addition on the first intermediate matrix and the first query matrix;
obtain a third intermediate matrix by performing linear transformation on the second intermediate matrix; and
obtain the first attention result by splicing the third intermediate matrix and the first content feature vector.

17. The electronic device according to claim 14, wherein the at least one processor is configured to execute the instructions to:
obtain a second query matrix for the attention determination by performing linear transformation on the second content feature vector;
obtain a second key matrix and a second value matrix for the attention determination by performing linear transformation on the second style feature vector; and
obtain the second attention result by performing the attention determination according to the second content feature vector, the second query matrix, the second key matrix and the second value matrix.

18. The electronic device according to claim 17, the at least one processor is configured to execute the instructions to:
obtain a second attention weight matrix by performing matrix multiplication on the second query matrix and the second key matrix;
obtain a fourth intermediate matrix by performing matrix multiplication on the second attention weight matrix and the second value matrix;
obtain a fifth intermediate matrix by performing matrix addition on the fourth intermediate matrix and the second query matrix;
obtain a sixth intermediate matrix by performing linear transformation on the fifth intermediate matrix; and
obtain the second attention result by splicing the sixth intermediate matrix and the second content feature vector.

19. The electronic device according to claim 12, wherein the at least one processor is configured to execute the instructions to:
determine a total loss value of the initial training model according to the first predicted handwritten text image, the second predicted handwritten text image and the first sample handwritten text image; and
train the initial training model by adjusting model parameters of the initial handwritten text image reconstruction model and the initial handwritten text image generation model according to the total loss value.

20. A non-transitory computer-readable storage medium having stored therein computer instructions that, when executed by a computer, cause the computer to:
obtain training data comprising a sample content image, a first sample handwritten text image and a second sample handwritten text image, wherein the first sample handwritten text image has a same writing style as the second sample handwritten text image and has a same text content as the sample content image, and the second sample handwritten text image has a different text content from the sample content image;
construct an initial training model comprising an initial handwritten text image generation model and an initial handwritten text image reconstruction model;
obtain a first predicted handwritten text image by inputting the sample content image and the second sample handwritten text image into the initial handwritten text image generation model;
obtain a second predicted handwritten text image by inputting the sample content image and the first sample handwritten text image into the initial handwritten text image reconstruction model;
train the initial training model according to the first predicted handwritten text image, the second predicted handwritten text image and the first sample handwritten text image; and
determine a handwritten text image generation model of the training model after training as a target handwritten text image generation model.
